(19) United States
(12) Patent Application Publication
(10) Pub. No.: US 2016/0323890 A1
(43) Pub. Date: Nov. 3, 2016

(54) APPARATUS, SYSTEM AND METHOD OF WIRELESS COMMUNICATION ACCORDING TO A BAND PLAN AND CHANNELIZATION

(71) Applicant: INTEL IP CORPORATION, Santa Clara, CA (US)

(72) Inventor: Carlos Cordeiro, Portland, OR (US)

(21) Appl. No.: 14/864,993

(22) Filed: Sep. 25, 2015

Related U.S. Application Data
(60) Provisional application No. 62/154,889, filed on Apr. 30, 2015.

(51) Int. Cl. H04W 72/04

(52) U.S. Cl. CPC H04W 72/0493; H04W 72/0446

(57) ABSTRACT

Some demonstrative embodiments include apparatuses, devices, systems and methods of wireless communication according to a band plan and channelization. For example, an apparatus may include circuitry configured to cause a wireless station to generate a frame configured for transmission over a millimeter Wave (mmWave) frequency band; and process directional transmission of the frame over a wide channel in the mmWave frequency band according to a band plan including a plurality of channels having a predefined channel width, and a plurality of wide channels including the wide channel, the wide channel having a width which is an integer multiple of the predefined channel width.

### CROSS REFERENCE

This Application claims the benefit of and priority from U.S. Provisional Patent Application No. 62/154,889 entitled “Apparatus, System and Method of Wireless Communication According to A Band Plan and Channelization”, filed Apr. 30, 2015, the entire disclosure of which is incorporated herein by reference.

### TECHNICAL FIELD

Embodiments described herein generally relate to wireless communication according to a band plan and/or channelization, for example, over a millimeterWave band.

### BACKGROUND

A wireless communication network in a millimeter-wave band may provide high-speed data access for users of wireless communication devices.

According to some Specifications and/or Protocols, devices may be configured to perform all transmissions and receptions over a single channel bandwidth (BW).

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative embodiments.

FIG. 2 is a schematic illustration of a non-overlapping band plan and channelization, in accordance with some demonstrative embodiments.

FIG. 3 is a schematic illustration of an overlapping band plan and channelization, in accordance with some demonstrative embodiments.

FIG. 4 is a schematic flow-chart illustration of a method of wireless communication according to a band plan and channelization, in accordance with some demonstrative embodiments

FIG. 5 is a schematic illustration of a product of manufacture, in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments” etc., indicate that the embodiment(s) so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some embodiments may be used in conjunction with various devices and systems, for example, a User Equipment (UE), a Mobile Device (MD), a wireless station (STA), a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with devices and/or networks operating in accordance with existing IEEE 802.11 standards (including IEEE 802.11-2012 (IEEE 802.11-2012, IEEE Standard for Information technology—Telecommunications and information exchange between systems Local and metropolitan area networks--Specific requirements Part 11: Wireless LAN Medium Access Control (MAC) and Physical Layer (PHY) Specifications, Mar. 29, 2012; IEEE802.11ac-2013 (“IEEE P802.11ac-2013, IEEE Standard for Information Technology—Telecommunications and Information Exchange Between Systems—Local and Metropolitan Area Networks—Specific Requirements—Part 11: Wireless LAN Medium Access Control (MAC) and Physical Layer (PHY) Specifications—Amendment 4: Enhancements for Very High Throughput for Operation in Bands below 6 GHz”, December, 2013); IEEE 802.11ad (“IEEE P802.11ad-2012, IEEE Standard for Information Technology—Telecommunications and Information Exchange Between Systems—Local and Metropolitan Area Networks—Specific Requirements—Part 11: Wireless LAN Medium Access Control (MAC) and Physical Layer (PHY) Specifications—Amendment 3: Enhancements for Very High Throughput in the 60 GHz Band”, 28 December, 2012); IEEE-802.11REVmc (“IEEE 802.11-REVmc™/D3.0, June 2014 draft standard for Information technology—Telecommunications and information exchange between systems Local and metropolitan area networks Specific requirements; Part 11: Wireless LAN Medium Access Control (MAC) and Physical Layer (PHY) Specification”); IEEE802.11-ay (P802.11 ay Standard for Information Technology—Telecommunications and Information Exchange Between Systems Local and Metropolitan Area Networks—Specific Requirements Part 11: Wireless LAN Medium Access Control (MAC) and Physical Layer (PHY) Specifications—Amendment: Enhanced Throughput for Operation in License-Exempt Bands Above 45 GHz)) and/or future versions and/or derivatives thereof, devices and/or networks operating in accordance with existing Wireless-Gigabit-Alliance (WGA) specifications (Wireless Gigabit Alliance, Inc WiGig MAC and PHY Specification Version 1.1, April 2011, Final specification) and/or future versions and/or derivatives thereof, devices and/or networks operating in accordance with existing Wireless Fidelity (WiFi) Alliance (WFA) Peer-to-Peer (P2P) specifications (including “WiFi Peer-to-Peer (P2P) technical specification, version 1.5, Aug. 4, 2014”) and/or future versions and/or derivatives thereof, devices and/or networks operating in accordance with existing cellular specifications and/or protocols, e.g., 3rd Generation Partnership Project (3GPP), 3GPP Long Term Evolution (LTE) and/or future versions and/or derivatives thereof, units and/or devices which are part of the above networks, and the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may be used in conjunction with one or more types of wireless communication signals and/or systems, for example, Radio Frequency (RF), Infra Red (IR), Frequency-Division Multiplexing (FDM), Orthogonal FDM (OFDM), Orthogonal Frequency-Division Multiple Access (OFDMA), FDM Time-Division Multiplexing (TDM), Time-Division Multiple Access (TDMA), Multi-User MIMO (MU-MIMO), Spatial Division Multiple Access (SDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G), or Sixth Generation (6G) mobile networks, 3GPP, Long Term Evolution (LTE), LTE advanced, Enhanced Data rates for GSM Evolution (EDGE), or the like. Other embodiments may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative embodiments, a wireless device may be or may include a peripheral that is integrated with a computer, or a peripheral that is attached to a computer. In some demonstrative embodiments, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device.

As used herein, the term “circuitry” may refer to, be part of, or include, an Application Specific Integrated Circuit (ASIC), an integrated circuit, an electronic circuit, a processor (shared, edicated, or group), and/or memory (shared, dedicated, d group or), that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware.

Some demonstrative embodiments may be used in conjunction with a WLAN, e.g., a wireless fidelity (WiFi) network. Other embodiments may be used in conjunction with any other suitable wireless communication network, for example, a wireless area network, a “piconet”, a WPAN, a WVAN and the like.

Some demonstrative embodiments may be used in conjunction with a wireless communication network communicating over a frequency band of 60 GHz. However, other embodiments may be implemented utilizing any other suitable wireless communication frequency bands, for example, an Extremely High Frequency (EHF) band (the millimeter wave (mmWave) frequency band), e.g., a frequency band within the frequency band of between 20 Ghz and 300 GHZ, a WLAN frequency band, a WPAN frequency band, a frequency band according to the WGA specification, and the like.

The term “antenna”, as used herein, may include any suitable configuration, structure and/or arrangement of one or more antenna elements, components, units, assemblies and/or arrays. In some embodiments, the antenna may implement transmit and receive functionalities using separate transmit and receive antenna elements. In some embodiments, the antenna may implement transmit and receive functionalities using common and/or integrated transmit/receive elements. The antenna may include, for example, a phased array antenna, a single element antenna, a set of switched beam antennas, and/or the like.

The phrases “directional multi-gigabit (DMG)” and “directional band” (DBand), as used herein, may relate to a frequency band wherein the Channel starting frequency is above 45 GHz. In one example, DMG communications may involve one or more directional links to communicate at a rate of multiple gigabits per second, for example, at least 1 Gigabit per second, e.g., 7 Gigabit per second, or any other rate.

Some demonstrative embodiments may be implemented by a DMG STA (also referred to as a “mmWave STA (mSTA)”), which may include for example, a STA having a radio transmitter, which is capable of operating on a channel that is within the DMG band. The DMG STA may perform other additional or alternative functionality. Other embodiments may be implemented by any other apparatus, device and/or station.

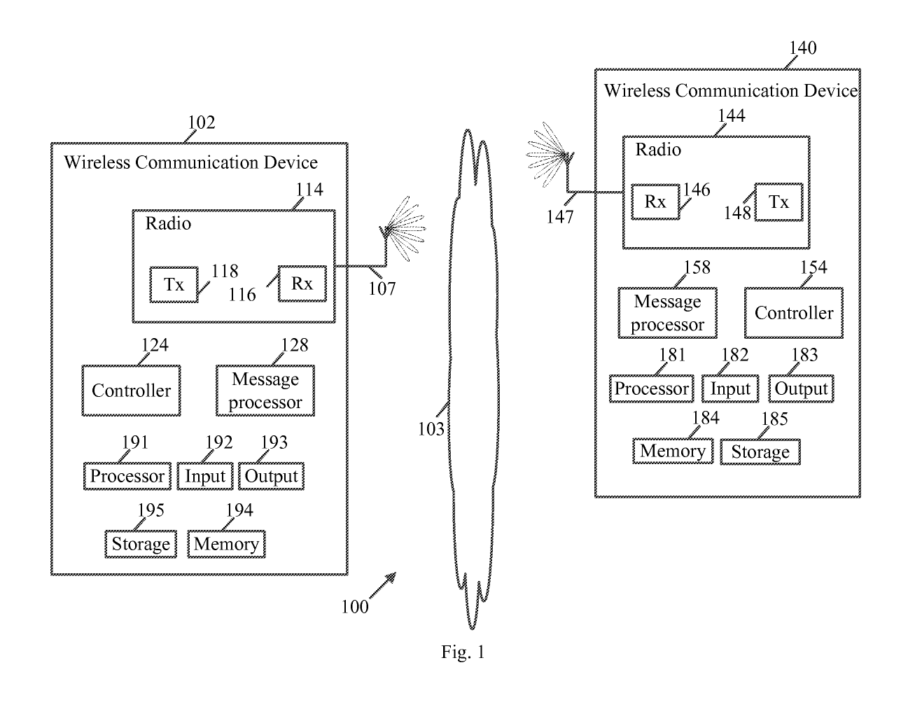

Reference is made to FIG. 1, which schematically illustrates a system 100, in accordance with some demonstrative embodiments.

As shown in FIG. 1, in some demonstrative embodiments, system 100 may include one or more wireless communication devices. For example, system 100 may include a first wireless communication device 102, and/or a second wireless communication device 140.

In some demonstrative embodiments, devices 102 and/or 140 may include a mobile device or a non-mobile, e.g., a static, device. For example, devices 102 and/or 140 may include, for example, a UE, an MD, a STA, an AP, a PC, a desktop computer, a mobile computer, a laptop computer, an Ultrabook™ computer, a notebook computer, a tablet computer, a server computer, a handheld computer, a handheld device, an Internet of Things (IoT) device, a sensor device, a wearable device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a flat panel display, a Personal Media Player (PMP), a digital video camera (DVC), a digital audio player, a speaker, an audio receiver, an audio amplifier, a gaming device, a data source, a data sink, a Digital Still camera (DSC), a media player, a Smartphone, a television, a music player, or the like.

In some demonstrative embodiments, device 102 may include, for example, one or more of a processor 191, an input unit 192, an output unit 193, a memory unit 194, and/or a storage unit 195; and/or device 140 may include, for example, one or more of a processor 181, an input unit 182, an output unit 183, a memory unit 184, and/or a storage unit 185. Devices 102 and/or 140 may optionally include other suitable hardware components and/or software components. In some demonstrative embodiments, some or all of the components of one or more of devices 102 and/or 140 may be enclosed in a common housing or packaging, and may be interconnected or operably associated using one or more wired or wireless links. In other embodiments, components of one or more of devices 102 and/or 140 may be distributed among multiple or separate devices.

In some demonstrative embodiments, processor 191 and/or processor 181 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 executes instructions, for example, of an Operating System (OS) of device 102 and/or of one or more suitable applications. Processor 181 executes instructions, for example, of an Operating System (OS) of device 140 and/or of one or more suitable applications.

In some demonstrative embodiments, input unit 192 and/or input unit 182 may include, for example, a keyboard, a keypad, a mouse, a touch-screen, a touch-pad, a track-ball, a stylus, a microphone, or other suitable pointing device or input device. Output unit 193 and/or output unit 183 may include, for example, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative embodiments, memory unit 194 and/or memory unit 184 may include, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 and/or storage unit 185 may include, for example, a hard disk drive, a floppy disk drive, a Compact Disk (CD) drive, a CD-ROM drive, a DVD drive, or other suitable removable or non-removable storage units. Memory unit 194 and/or storage unit 195, for example, may store data processed by device 102. Memory unit 184 and/or storage unit 185, for example, may store data processed by device 140.

In some demonstrative embodiments, wireless communication devices 102 and/or 140 may be capable of communicating content, data, information and/or signals via a wireless medium (WM) 103. In some demonstrative embodiments, wireless medium 103 may include, for example, a radio channel, a cellular channel, an RF channel, a Wireless Fidelity (WiFi) channel, an IR channel, a Bluetooth (BT) channel, a Global Navigation Satellite System (GNSS) Channel, and the like.

In some demonstrative embodiments, WM 103 may include one or more directional bands and/or channels. For example, WM 103 may include one or more millimeter-wave (mmWave) wireless communication bands and/or channels.

In some demonstrative embodiments, WM 103 may include one or more DMG channels. In other embodiments WM 103 may include any other directional channels.

In other embodiments, WM 103 may include any other type of channel over any other frequency band.

In some demonstrative embodiments, devices 102 and/or 140 may include, operate as, and/or perform the functionality of, one or more wireless stations, e.g., as described below.

In some demonstrative embodiments, devices 102 and/or 140 may include, operate as, and/or perform the functionality of, one or more DMG stations.

In other embodiments, devices 102 and/or 140 may include, operate as, and/or perform the functionality of, any other wireless device and/or station, e.g., a WLAN STA, a WiFi STA, and the like.

In some demonstrative embodiments, devices 102 and/or 140 may include one or more radios including circuitry and/or logic configured to perform wireless communication between devices 102, 140 and/or one or more other wireless communication devices. For example, device 102 may include a radio 114, and/or device 140 may include a radio 144.

In some demonstrative embodiments, radios 114 and/or 144 may include one or more wireless receivers (Rx) including circuitry and/or logic configured to receive wireless communication signals, RF signals, frames, blocks, transmission streams, packets, messages, data items, and/or data. For example, radio 114 may include a receiver 116, and/or radio 144 may include a receiver 146.

In some demonstrative embodiments, radios 114 and/or 144 may include one or more wireless transmitters (Tx) including circuitry and/or logic configured to send wireless communication signals, RF signals, frames, blocks, transmission streams, packets, messages, data items, and/or data. For example, radio 114 may include a transmitter 118, and/or radio 144 may include a transmitter 148.

In some demonstrative embodiments, radios 114 and/or 144 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like. For example, radios 114 and/or 144 may include or may be implemented as part of a wireless Network Interface Card (NIC), and the like.

In some demonstrative embodiments, radios 114 and/or 144 may include, or may be associated with, one or more antennas 107 and/or 147, respectively.

In one example, device 102 may include a single antenna 107. In another example, device 102 may include two or more antennas 107.

In one example, device 140 may include a single antenna 147. In another example, device 140 may include two or more antennas 147.

Antennas 107 and/or 147 may include any type of antennas suitable for transmitting and/or receiving wireless communication signals, blocks, frames, transmission streams, packets, messages and/or data. For example, antennas 107 and/or 147 may include any suitable configuration, structure and/or arrangement of one or more antenna elements, components, units, assemblies and/or arrays. Antennas 107 and/or 147 may include, for example, antennas suitable for directional communication, e.g., using beamforming techniques. For example, antennas 107 and/or 147 may include a phased array antenna, a multiple element antenna, a set of switched beam antennas, and/or the like. In some embodiments, antennas 107 and/or 147 may implement transmit and receive functionalities using separate transmit and receive antenna elements. In some embodiments, antennas 107 and/or 147 may implement transmit and receive functionalities using common and/or integrated transmit/receive elements.

In some demonstrative embodiments, antennas 107 and/or 147 may include a directional antenna, which may be steered to a plurality of beam directions. For example, antenna 107 may be steered to a plurality of beam directions 135, and/or antenna 147 may be steered to a plurality of beam directions 145. For example, device 102 may transmit a directional transmission 139 to device 140, and/or device 140 may transmit a directional transmission 149 to device 102.

In some demonstrative embodiments, device 102 may include a controller 124, and/or device 140 may include a controller 154. Controllers 124 and/or 154 may be configured to perform one or more communications, may generate and/or communicate one or more messages and/or transmissions, and/or may perform one or more functionalities, operations and/or procedures between devices 102, 140 and/or 160 and/or one or more other devices, e.g., as described below.

In some demonstrative embodiments, controllers 124 and/or 154 may include circuitry and/or logic, e.g., one or more processors including circuitry and/or logic, memory circuitry and/or logic, Media-Access Control (MAC) circuitry and/or logic, Physical Layer (PHY) circuitry and/or logic, and/or any other circuitry and/or logic, configured to perform the functionality of controllers 124 and/or 154, respectively. Additionally or alternatively, one or more functionalities of controllers 124 and/or 154 may be implemented by logic, which may be executed by a machine and/or one or more processors, e.g., as described below.

In one example, controller 124 may include circuitry and/or logic, for example, one or more processors including circuitry and/or logic, to cause a wireless device, e.g., device 102, and/or a wireless station, e.g., a wireless STA implemented by device 102, to perform one or more operations, communications and/or functionalities, e.g., as described herein.

In one example, controller 154 may include circuitry and/or logic, for example, one or more processors including circuitry and/or logic, to cause a wireless device, e.g., device 140, and/or a wireless station, e.g., a wireless STA implemented by device 140, to perform one or more operations, communications and/or functionalities, e.g., as described herein.

In some demonstrative embodiments, device 102 may include a message processor 128 configured to generate, process and/or access one or messages communicated by device 102.

In one example, message processor 128 may be configured to generate one or more messages to be transmitted by device 102, and/or message processor 128 may be configured to access and/or to process one or more messages received by device 102, e.g., as described below.

In some demonstrative embodiments, device 140 may include a message processor 158 configured to generate, process and/or access one or messages communicated by device 140.

In one example, message processor 158 may be configured to generate one or more messages to be transmitted by device 140, and/or message processor 158 may be configured to access and/or to process one or more messages received by device 140, e.g., as described below.

In some demonstrative embodiments, message processors 128 and/or 158 may include circuitry, e.g., processor circuitry, memory circuitry, Media-Access Control (MAC) circuitry, Physical Layer (PHY) circuitry, and/or any other circuitry, configured to perform the functionality of message processors 128 and/or 158. Additionally or alternatively, one or more functionalities of message processors 128 and/or 158 may be implemented by logic, which may be executed by a machine and/or one or more processors, e.g., as described below.

In some demonstrative embodiments, at least part of the functionality of message processor 128 may be implemented as part of radio 114, and/or at least part of the functionality of message processor 158 may be implemented as part of radio 144.

In some demonstrative embodiments, at least part of the functionality of message processor 128 may be implemented as part of controller 124, and/or at least part of the functionality of message processor 158 may be implemented as part of controller 154.

In other embodiments, the functionality of message processor 128 may be implemented as part of any other element of device 102, and/or the functionality of message processor 158 may be implemented as part of any other element of device 140.

In some demonstrative embodiments, at least part of the functionality of controller 124 and/or message processor 128 may be implemented by an integrated circuit, for example, a chip, e.g., a System on Chip (SoC). In one example, the chip or SoC may be configured to perform one or more functionalities of radio 114. For example, the chip or SoC may include one or more elements of controller 124, one or more elements of message processor 128, and/or one or more elements of radio 114. In one example, controller 124, message processor 128, and radio 114 may be implemented as part of the chip or SoC.

In other embodiments, controller 124, message processor 128, and/or radio 114 may be implemented by one or more additional or alternative elements of device 102.

In some demonstrative embodiments, at least part of the functionality of controller 154 and/or message processor 158 may be implemented by an integrated circuit, for example, a chip, e.g., a SoC. In one example, the chip or SoC may be configured to perform one or more functionalities of radio 144. For example, the chip or SoC may include one or more elements of controller 154, one or more elements of message processor 158, and/or one or more elements of radio 144. In one example, controller 154, message processor 158, and radio 144 may be implemented as part of the chip or SoC.

In other embodiments, controller 154, message processor 158, and/or radio 144 may be implemented by one or more additional or alternative elements of device 140.

In some demonstrative embodiments, devices 102 and/or 140 may be configured to operate as, and/or to perform the functionality of, an access point (AP), e.g., a DMG AP, and/or a personal basic service set (PBSS) control point (PCP), e.g., a DMG PCP, for example, an AP/PCP STA, e.g., a DMG AP/PCP STA.

In some demonstrative embodiments, devices 102 and/or 140 may be configured to operate as, and/or to perform the functionality of, a non-AP STA, e.g., a DMG non-AP STA, and/or a non-PCP STA, e.g., a DMG non-PCP STA, for example, a non-AP/PCP STA, e.g., a DMG non-AP/PCP STA.

In one example, a station (STA) may include a logical entity that is a singly addressable instance of a medium access control (MAC) and physical layer (PHY) interface to the wireless medium (WM). The STA may perform any other additional or alternative functionality.

In one example, an AP may include an entity that contains a station (STA), e.g., one STA, and provides access to distribution services, via the wireless medium (WM) for associated STAs. The AP may perform any other additional or alternative functionality.

In one example, a personal basic service set (PBSS) control point (PCP) may include an entity that contains a STA, e.g., one station (STA), and coordinates access to the wireless medium (WM) by STAs that are members of a PBSS. The PCP may perform any other additional or alternative functionality.

In one example, a PBSS may include a directional multi-gigabit (DMG) basic service set (BSS) that includes, for example, one PBSS control point (PCP). For example, access to a distribution system (DS) may not be present, but, for example, an intra-PBSS forwarding service may optionally be present.

In one example, a PCP/AP STA may include a station (STA) that is at least one of a PCP or an AP. The PCP/AP STA may perform any other additional or alternative functionality.

In one example, a non-AP STA may include a STA that is not contained within an AP. The non-AP STA may perform any other additional or alternative functionality.

In one example, a non-PCP STA may include a STA that is not a PCP. The non-PCP STA may perform any other additional or alternative functionality.

In one example, a non PCP/AP STA may include a STA that is not a PCP and that is not an AP. The non-PCP/AP STA may perform any other additional or alternative functionality.

Some communications over a wireless communication band, for example, a DMG band or any other band, may be performed over a single channel bandwidth (BW). For example, the IEEE 802.11ad Specification defines a 60 GHz system with a single channel bandwidth (BW) of 2.16 GHz, which is to be used by all Stations (STAs) for both transmission and reception.

In some demonstrative embodiments, devices 102 and/or 140 may be configured to implement one or more mechanisms, which may, for example, enable to extend a single-channel BW scheme, e.g., a scheme in accordance with the IEEE 802.11ay Specification or any other scheme, for higher data rates and/or increased capabilities, e.g., as described below.

In some demonstrative embodiments, devices 102 and/or 140 may be configured to implement one or more channel bonding mechanisms, which may, for example, support communication over contiguous and/or non-contiguous bonded channels.

In some demonstrative embodiments, the channel bonding may include, for example, a mechanism and/or an operation whereby two or more channels can be combined, e.g., for a higher bandwidth of packet transmission, for example, to enable achieving higher data rates, e.g., when compared to transmissions over a single channel.

In one example, two or more adjacent channels may be combined to form a contiguous bonded communication channel for transmission and/or reception of frames.

In another example, two or more non-adjacent channels may be combined to form a non-contiguous bonded communication channel for transmission and/or reception of frames.

In some demonstrative embodiments, devices 102 and/or 140 may be configured to implement one or more channel bonding mechanisms, which may, for example, support an increased channel bandwidth, for example, a channel BW of 4.32 GHz, a channel BW of 6.48 GHz, a channel BW of 8.64 GHz, and/or any other additional or alternative channel BW.

Some demonstrative embodiments are described herein with respect to a bonded channel including a plurality of channels.

In other embodiments, some mechanisms and/or schemes describes herein may be implemented, additionally and/or alternatively, to communicative over an aggregated channel by an aggregation of a plurality of channels.

In one example, an aggregated channel may include an aggregate of two or more contiguous channels. For example, two or more adjacent channels may be combined to form a contiguous aggregated communication channel for transmission and/or reception of frames.

In another example, an aggregated channel may include an aggregate of two or more non-contiguous channels. For example, two or more non-adjacent channels may be combined to form a non-contiguous communication channel for transmission and/or reception of frames.

Some specifications, e.g., an IEEE 802.11ad Specification, may be configured to support a Single User (SU) system, in which a Station (STA) cannot transmit frames to more than a single STA at a time. Such Specifications may not be able, for example, to support transmission from a STA to multiple STAs simultaneously, for example, using a multi-user MIMO (MU-MIMO) scheme, e.g., a downlink (DL) MU-MIMO, or any other MU scheme.

In some demonstrative embodiments, devices 102 and/or 140 may be configured to implement one or more Multi-User (MU) mechanisms. For example, devices 102 and/or 140 may be configured to implement one or more MU mechanisms, which may be configured to enable MU communication with channel bonding.

In one example, devices 102 and/or 140 may be configured to implement one or more MU mechanisms, which may be configured to enable, for example, MU communication of Downlink (DL) frames using a Multiple-Input-Multiple-Output (MIMO) scheme, for example, between a device, e.g., device 102, and a plurality of devices, e.g., including device 140 and/or one or more other devices.

In some demonstrative embodiments, devices 102 and/or 140 may be configured to implement any other additional or alternative MU mechanism, e.g., to communicate MU transmissions, and/or any other MIMO mechanism, e.g., to communicate MIMO transmissions.

In some demonstrative embodiments, a communication scheme may be configured to include changes to an existing standard, for example, a legacy standard, e.g., the IEEE 802.11ad standard, for example, in a Physical layer (PHY) and/or a Media Access Control (MAC) layer, e.g., to support channel bonding and/or MU capabilities, e.g., as described below.

In other embodiments, a new and/or independent communication scheme may include a PHY layer and/or MAC layer and/or any other layer, which may be configured to support channel bonding and/or MU capabilities, e.g., as described below.

Some demonstrative embodiments may include a new band plan and channelization, which may be implemented, for example, as part of an IEEE 802.11 Specification, for example, an IEEE 802.11ay Specification, and/or any other Specification or protocol.

In some demonstrative embodiments, a band plan and channelization may be configured, for example, to support channel bonding, e.g., as described below.

In some demonstrative embodiments, devices 102 and/or 140 may be configured to communicate according to a band plan, which may enable one or more channel widths, e.g., in addition to, or instead of, a predefined channel width.

In some demonstrative embodiments, devices 102 and/or 140 may be configured to communicate according to a band plan, which may use one or more additional channel widths, which are wider than 2.16 Gigahertz (GHz), e.g., as described below.

In some demonstrative embodiments, device 102 may be configured to generate a frame configured for transmission over a millimeter Wave (mmWave) frequency band.

In some demonstrative embodiments, controller 124 may be configured to control, cause and/or trigger a wireless station, for example, a wireless station implemented by device 102, to generate the frame, e.g., as described below. For example, controller 124 may control, cause and/or trigger message processor 128 and/or radio 114 to generate and/or transmit the frame.

In some demonstrative embodiments, device 102 may process directional transmission of the frame over a wide channel in the mmWave frequency band according to a band plan, e.g., as described below.

In some demonstrative embodiments, the band plan may include a plurality of channels having a predefined channel width, and a plurality of wide channels, e.g., as described below.

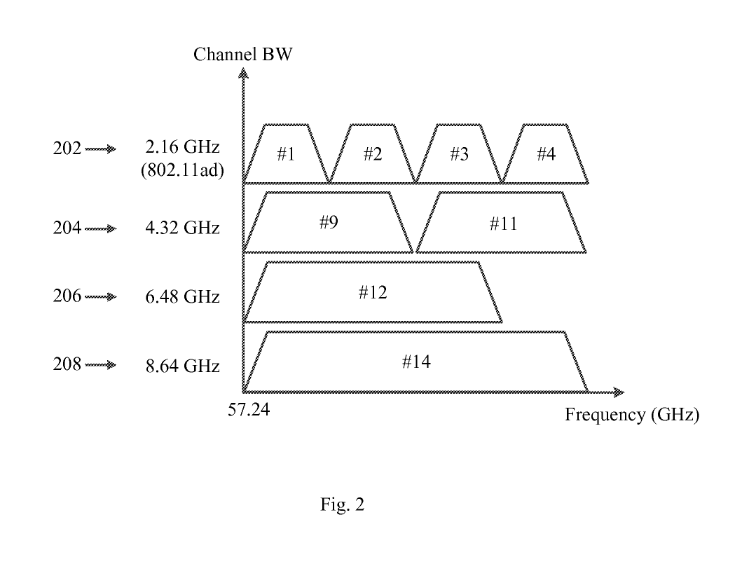

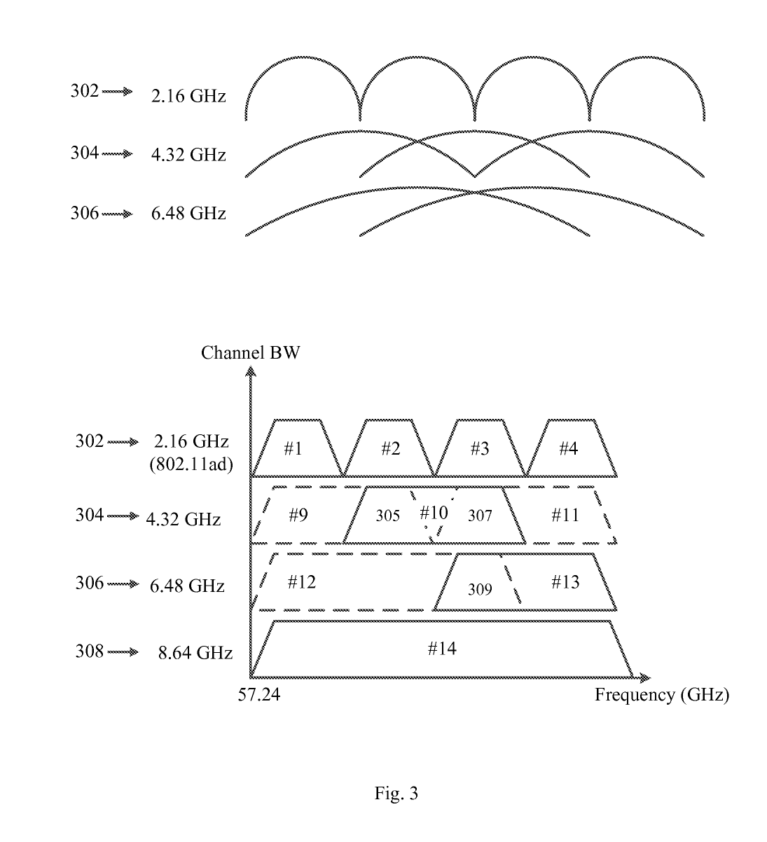

In some demonstrative embodiments, the plurality of channels having the predefined channel width may include four channels having the channel width of 2.16 Gigahertz (GHz), e.g., as described below with reference to FIG. 2 and/or FIG. 3.

In some demonstrative embodiments, controller 124 may be configured to select the wide channel for a wireless transmission from a plurality of wide channels of the band plan, e.g., as described below.

In some demonstrative embodiments, the wide channel may have a width which is an integer multiple of the predefined channel width. For example, the width of the wide channel may be, for example, at least two, three, or four times the width of the predefined channel.

In some demonstrative embodiments, the wide channel may include at least two channels of the plurality of channels having the predefined channel width.

In some demonstrative embodiments, the wide channel may include a bonded channel formed by at least two contiguous channels.

In some demonstrative embodiments, the wide channel may include an aggregated channel formed by at least two non-contiguous channels.

In some demonstrative embodiments, each wide channel of the plurality of wide channels may include a different combination of at least two of the plurality of channels having the predefined channel width, e.g., as described below.

In some demonstrative embodiments, the plurality of wide channels may include at least two wide channels having a channel width of 4.32 Gigahertz (GHz).

In some demonstrative embodiments, the plurality of wide channels may include one or more channels having a channel width of 6.48 Gigahertz (GHz).

In some demonstrative embodiments, the plurality of wide channels may include a channel having a channel width of 8.64 Gigahertz (GHz).

In one example, devices 102 and/or 140 may be configured to communicate according to a band plan, which may enable a channel width of 4.32 GHz, e.g., which may be suitable for a two-channel bonding; a channel width of 6.48 GHz, e.g., which may be suitable for a 3-channel bonding; a channel width of 8.64 GHz, e.g., which may be suitable for a 4-channel bonding; and/or any other additional or alternative channel width which may be suitable for any other channel bonding of any other number of channels.

In some demonstrative embodiments, devices 102 and/or 140 may be configured to communicate according to a non-overlapping band plan, e.g., as described below.

In some demonstrative embodiments, the non-overlapping band plan may be configured in consideration of one or more approaches of one or more IEEE 802.11 Standards, e.g., the IEEE 802.11ad-2012 and/or IEEE 802.11ay standards.

In some demonstrative embodiments, the plurality of wide channels may include first and second non-overlapping wide channels having a channel width of 4.32 GHz

In some demonstrative embodiments, the plurality of wide channels may include a single non-overlapping channel having a channel width of 6.48 GHz.

In some demonstrative embodiments, the plurality of wide channels may include a single non-overlapping channel having a channel width of 8.64 GHz.

In some demonstrative embodiments, devices 102 and/or 140 may be configured to communicate according to an overlapping band plan, e.g., as described below.

In some demonstrative embodiments, the overlapping band plan may be configured in consideration of one or more approaches of one or more IEEE 802.11 Standards, e.g., the IEEE 802.11ad-2012 and/or IEEE 802.11ay standards.

In some demonstrative embodiments, the overlapping band plan may be suitable for example, to communicate via directional transmissions, e.g., transmissions over the 60 GHz band, or any other directional communication band.

In some demonstrative embodiments, the overlapping band plan may utilize overlapping channelization, which may, for example, enable increasing a number of supported channels, e.g., as described below.

In some demonstrative embodiments, the plurality of wide channels in the overlapping band plan may include three overlapping wide channels each having a channel width of 4.32 GHz.

In some demonstrative embodiments, the plurality of wide channels in the overlapping band plan may include first and second overlapping channels each having a channel width of 6.48 GHz.

In some demonstrative embodiments, the plurality of wide channels in the overlapping band plan may include a channel having a channel width of 8.64 GHz, e.g., according to the overlapping band plan.

In some demonstrative embodiments, device 140 may be configured to receive a frame over a wide channel in the mmWave frequency band according to a band plan.

In some demonstrative embodiments, receiver 146 may be configured to receive the frame transmitted from device 102 over the wide channel in the mmWave frequency band according to the band plan.

In some demonstrative embodiments, device 140 may be configured to process directional reception of a frame over a wide channel in the mmWave frequency band according to a band plan.

In some demonstrative embodiments, controller 154 may be configured to control, cause and/or trigger a wireless station, for example, a wireless station implemented by device 140, to process the received frame, e.g., as described below. For example, controller 154 may control, cause and/or trigger message processor 158 and/or radio 114 to process reception of the frame.

In some demonstrative embodiments, device 140 may be configured to process directional reception of the frame transmitted from device 102 over a wide channel in the mmWave frequency band according to the band plan.

In some demonstrative embodiments, device 140 may be configured to process at least a portion of the frame.

In some demonstrative embodiments, controller 154 may be configured to control, cause and/or trigger a wireless station, for example, a wireless station implemented by device 140, to process at least the portion of the frame, e.g., the frame transmitted from device 102 according to the band plan.

In some demonstrative embodiments, device 140 may be configured to process directional reception of a frame over a wide channel having the channel width of 4.32 GHz, for example, if device 102 transmits the frame over the wide channel having the channel width of 4.32 GHz.

In some demonstrative embodiments, device 140 may be configured to process directional reception of a frame over a wide channel having the channel width of 6.48 GHz, for example, if device 102 transmits the frame over the wide channel having the channel width of 6.48 GHz.

In some demonstrative embodiments, device 140 may be configured to process directional reception of a frame over a wide channel having the channel width of 8.64 GHz, for example, if device 102 transmits the frame over the wide channel having the channel width of 8.64 GHz.

Reference is made to FIG. 2, which schematically illustrates a non-overlapping band plan and channelization 200, in accordance with some demonstrative embodiments. For example, devices 102 and/or 140 (FIG. 1) may be configured to communicate according to the band plan and channelization 200.

In some demonstrative embodiments, as shown in FIG. 2, non-overlapping band plan and channelization 200 may include a plurality of channels 202 having a predefined channel width may include four channels, denoted channel #1, Channel #2, Channel #3, and Channel #4.

As shown in FIG. 2, the plurality of channels 202 may be defined with a bandwidth of 2.16 GHz, e.g., in accordance with channels defined by the IEEE 802.11ad-2012 Specification.

As shown in FIG. 2, the band plan and channelization 200 may include first and second non-overlapping wide channels 204, denoted Chanel #9, and Chanel #11, each having a width of 4.32 GHz channels, for example, in addition to the 2.16 GHz channels.

As shown in FIG. 2, a channel of the first and second non-overlapping wide channels 204 may include two channels of the plurality of channels 202. For example, Chanel #9 may include Channel #1 and Channel #2, and/or Chanel #11 may include Channel #3 and Channel #4.

As shown in FIG. 2, a channel of the first and second non-overlapping wide channels 204 may include a bonded channel formed by the two channels. For example, Chanel #9 may include a bonded channel formed by Channel #1 and Channel #2, and/or Channel #11 may include a bonded channel formed by Channel #3 and Channel #4.

In other embodiments, plan and channelization 200 may include an aggregated channel formed by the two channels of plurality of channels 202.

In one example, the aggregated channel may be formed by two contiguous channels, e.g., an aggregated channel formed by Channel #3 and Channel #4, and/or an aggregated channel formed by Channel #1 and Channel #2.

In another example, the aggregated channel may be formed by two non-contiguous channels, e.g., an aggregated channel formed by Channel #1 and Channel #3, and/or an aggregated channel formed by Channel #2 and Channel #4.

As shown in FIG. 2, non-overlapping band plan 200 may include a 6.48 GHz channel 206, denoted Chanel #12, for example, in addition to the 4.32 GHz, and/or 2.16 GHz channels.

As shown in FIG. 2, non-overlapping band plan 200 may include a 8.64 GHz channel 208, denoted Channel #14, for example, in addition to the 6.48 GHz, 4.32 GHz, and/or 2.16 GHz channels.

In some demonstrative embodiments, as shown in FIG. 2, for a given channel BW, the wide channels, e.g., the 4.32 GHz, 8.64 GHz, and/or 6.48 GHz channels, are non-overlapping with each other.

In some demonstrative embodiments, a channel of band plan 200 may be defined, for example, based on a center frequency of the channel

In some demonstrative embodiments, a center frequency of a channel of band plan 200 may be determined, for example, based on a starting frequency of the channel, a channel number of the channel, and the channel spacing of the channel, e.g., as descried below.

In some demonstrative embodiments, the channel center frequency may be determined, for example, for the 4.32 GHz channels of FIG. 2, for example, in accordance with band plan 200, e.g., as follows:

Channel center frequency=Channel starting frequency+(Channel spacing/2)×(Channel number mod 8)+1.08 (GHz) (1)

wherein channel starting frequency may be, for example, 56.16 GHz, channel spacing may be, for example, 4.32 GHz, and/or channel number may include the Channel numbers denoted in FIG. 2, e.g., Channels #9 and #11 for the 4.32 GHz channels.

In some demonstrative embodiments, the channel center frequency may be determined, for example, for the 6.48 GHz channel of FIG. 2, for example, in accordance with the band plan 200, e.g., as follows:

Channel center frequency=Channel starting frequency+(Channel spacing/3)×(Channel number mod 10) (2)

wherein channel starting frequency may be, for example, 56.16 GHz, channel spacing may be, for example, 6.48 GHz, and/or channel number may include the Channel number denoted in FIG. 2, e.g., Channel #12.

In some demonstrative embodiments, the channel center frequency may be determined, for example, for the 8.64 GHz channel of FIG. 2, for example, in accordance with the band plan 200, e.g., as follows:

Channel center frequency=Channel starting frequency+(Channel spacing/4)×(Channel number mod 12)+1.08 (GHz) (3)

wherein channel starting frequency may be, for example, 56.16 GHz, channel spacing may be, for example, 8.64 GHz, and/or channel number may include the Channel number denoted in FIG. 2, e.g., Channel #14.

Reference is made to FIG. 3, which schematically illustrates an overlapping band plan and channelization 300, in accordance with some demonstrative embodiments. For example, devices 102 and/or 140 (FIG. 1) may be configured to communicate according to the band plan 300.

In some demonstrative embodiments, as shown in FIG. 3, overlapping band plan and channelization 300 may include a plurality of channels 302 having a predefined channel width, e.g., including four channels, denoted channel #1, Channel #2, Channel #3, and Channel #4.

As shown in FIG. 3, the plurality of channels 302 may be defined with a bandwidth of 2.16 GHz, e.g., in accordance with channels defined by the IEEE 802.11ad-2012 Specification.

In some demonstrative embodiments, as shown in FIG. 3, band plan and channelization 300 may include a plurality of overlapping wide channels 304, denoted Chanel #9, Channel #10, and Chanel #11, each having a width of 4.32 GHz, for example, in addition to the 2.16 GHz channels.

As shown in FIG. 3, Channel #10 and Channel #9 may have a first overlapping portion 305, and/or Channel #10 and Channel #11 may have a second overlapping portion 307.

As shown in FIG. 3, a channel of the plurality of overlapping wide channels 304 may include two channels of the plurality of channels 302. For example, Chanel #9 may include Channel #1 and Channel #2, Chanel #10 may include Channel #2 and Channel #3, and/or Chanel #11 may include Channel #3 and Channel #4.

As shown in FIG. 3, a channel of the plurality of overlapping wide channels 304 may include a bonded channel formed by the two channels of the plurality of channels 302. For example, Chanel #9 may include a bonded channel formed by Channel #1 and Channel #2, Chanel #10 may include a bonded channel formed by Channel #2 and Channel #3, and/or Chanel #11 may include a bonded channel formed by Channel #3 and Channel #4.

In other embodiments, plan and channelization 300 may include an aggregated channel formed by two channels of the plurality of channels 302.

In one example, the aggregated channel may be formed by two contiguous channels, e.g., an aggregated channel formed by Channel #3 and Channel #4, and/or an aggregated channel formed by Channel #2 and Channel #3.

In one example, the aggregated channel may be formed by two non-contiguous channels, e.g., an aggregated channel formed by Channel #1 and Channel #3, and/or an aggregated channel formed by Channel #1 and Channel #4.

In some demonstrative embodiments, as shown in FIG. 3, band plan and channelization 300 may include first and second overlapping wide channels 306, denoted Chanel #12, and Channel #13, each having a width of 6.48 GHz, for example, in addition to the 4.32 GHz and/or 2.16 GHz channels.

As shown in FIG. 3, Channel #12 and Channel #13 may have an overlapping portion 309.

In some demonstrative embodiments, as shown in FIG. 3, overlapping band plan 300 may include a 8.64 GHz channel 306, denoted Chanel #14, for example, in addition to the 6.48 GHz, 4.32 GHz and/or 2.16 GHz channels.

In some demonstrative embodiments, according to the overlapping channelization plan 300, for a given channel BW there may be one more overlapping channel, e.g., in opposed to the non-overlapping channelization 200 (FIG. 2).

For example, for 6.48 GHz channels, overlapping channelization plan 300 may include 2 channels, e.g., Channel #12 and Channel #13, compared to non-overlapping channelization plan 200 (FIG. 2), which may include only one channel, e.g., channel #12.

In some demonstrative embodiments, communicating according to overlapping band plan and channelization 300 may enable overlap between channels, which may increase the number of operating channels, e.g., as descried above.

In some demonstrative embodiments, communicating according to overlapping band plan and channelization 300 may enable overlap between channels, which may, for example, increase the likelihood of interference, e.g., particularly in denser deployments. However, implementing overlapping band plan 300 with respect to directional transmissions, for example, directional transmissions in a 60 GHz band, may enable considering the channelization of overlapping band plan and channelization 300 to be a feasible alternative to a non-overlapping channelization.

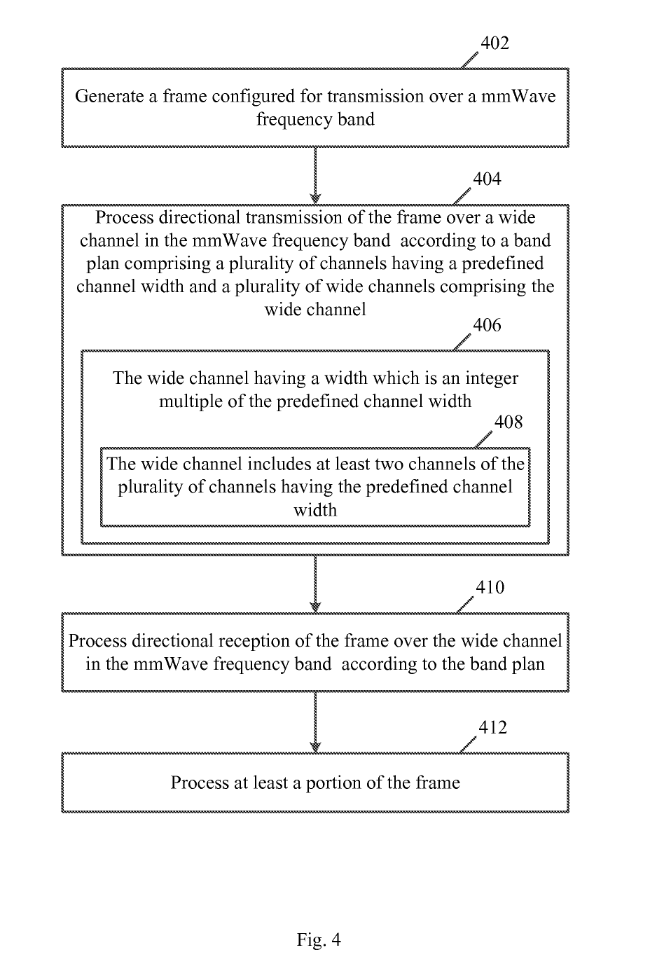

Reference is made to FIG. 4, which schematically illustrates a method of wireless communication according to a band plan and channelization, in accordance with some demonstrative embodiments. For example, one or more of the operations of the method of FIG. 4 may be performed by one or more elements of a system, e.g., system 100 (FIG. 1), for example, one or more wireless devices, e.g., device 102 (FIG. 1) and/or device 140 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 402, the method may include generating a frame configured for transmission over a mmWave frequency band. For example, controller 124 (FIG. 1) may control, cause and/or trigger message processor 128 (FIG. 1) to generate the frame for transmission over the mmWave frequency band, e.g., as described above.

As indicated at block 404, the method may include processing directional transmission of the frame over a wide channel in the mmWave frequency band according to a band plan including a plurality of channels having a predefined channel width, and a plurality of wide channels including the wide channel. For example, controller 124 (FIG. 1) may control, cause and/or trigger message processor 128 (FIG. 1) and/or radio 114 (FIG. 1) to process transmission of the frame over the wide channel in the mmWave frequency band according to the band plan 200 (FIG. 2); and/or controller 124 (FIG. 1) may control, cause and/or trigger message processor 128 (FIG. 1) and/or radio 114 (FIG. 1) to process transmission of the frame over the wide channel in the mmWave frequency band according to the band plan 300 (FIG. 3), e.g., as described above.

As indicated at block 406, processing the directional transmission of the frame over the wide channel may include processing the directional transmission of the frame over a wide channel having a width which is an integer multiple of the predefined channel width. For example, controller 124 (FIG. 1) may control, cause and/or trigger message processor 128 (FIG. 1) and/or radio 114 (FIG. 1) to process transmission of the frame over the wide channel in the mmWave frequency band according to the band plan 200 (FIG. 2); and/or controller 124 (FIG. 1) may control, cause and/or trigger message processor 128 (FIG. 1) and/or radio 114 (FIG. 1) to process transmission of the frame over the wide channel #9 of band plan 200 (FIG. 2) or band plan 300 (FIG. 3), e.g., as described above.

As indicated at block 408, processing the directional transmission of the frame over the wide channel may include processing the directional transmission of the frame over a wide channel including at least two channels of the plurality of channels having the predefined channel width. For example, controller 124 (FIG. 1) may control, cause and/or trigger message processor 128 (FIG. 1) and/or radio 114 (FIG. 1) to process transmission of the frame over the wide channel #9 of band plan 200 (FIG. 2), which includes channels #1 and #2 of band plan 200 (FIG. 2); and/or controller 124 (FIG. 1) may control, cause and/or trigger message processor 128 (FIG. 1) and/or radio 114 (FIG. 1) to process transmission of the frame over the wide channel #9 of band plan 300 (FIG. 3), which includes channels #1 and #2 of band plan 300 (FIG. 3), e.g., as described above.

As indicated at block 410, the method may include processing directional reception of the frame in the mmWave frequency band over the wide channel according to the band plan. For example, controller 154 (FIG. 1) may control, cause and/or trigger message processor 158 (FIG. 1) and/or radio 144 (FIG. 1) to process reception of the frame in the mmWave frequency band over the wide channel according to band plan 200 (FIG. 2), or according to band plan 300 (FIG. 3), e.g., as described above.

As indicated at block 412, the method may include processing at least a portion of the frame. For example, controller 154 (FIG. 1) may control, cause and/or trigger message processor 158 (FIG. 1) and/or radio 144 (FIG. 1) to process the portion of the frame, e.g., as described above.

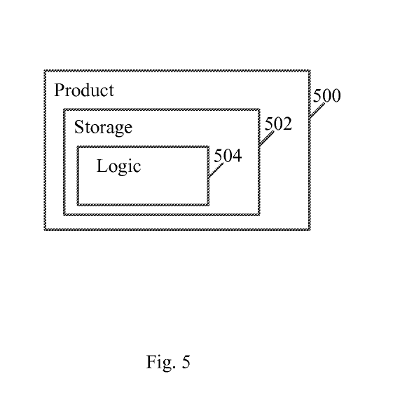

Reference is made to FIG. 5, which schematically illustrates a product of manufacture 500, in accordance with some demonstrative embodiments. Product 500 may include a non-transitory machine-readable storage medium 502 to store logic 504, which may be used, for example, to perform at least part of the functionality of devices 102 and/or 140 (FIG. 1), transmitters 118 and/or 148 (FIG. 1), receivers 116 and/or 146 (FIG. 1), controllers 124 and/or 154 (FIG. 1), message processors 128 (FIG. 1) and/or 158 (FIG. 1), and/or to perform one or more operations and/or functionalities, for example, one or more operations of the method of FIG. 4. The phrase “non-transitory machine-readable medium” is directed to include all computer-readable media, with the sole exception being a transitory propagating signal.

In some demonstrative embodiments, product 500 and/or machine-readable storage medium 502 may include one or more types of computer-readable storage media capable of storing data, including volatile memory, non-volatile memory, removable or non-removable memory, erasable or non-erasable memory, writeable or re-writeable memory, and the like. For example, machine-readable storage medium 502 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory, phase-change memory, ferroelectric memory, silicon-oxide-nitride-oxide-silicon (SONOS) memory, a disk, a floppy disk, a hard drive, an optical disk, a magnetic disk, a card, a magnetic card, an optical card, a tape, a cassette, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative embodiments, logic 504 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative embodiments, logic 504 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, such as C, C++, Java, BASIC, Matlab, Pascal, Visual BASIC, assembly language, machine code, and the like.

### EXAMPLES

The following examples pertain to further embodiments.

Example 1 includes an apparatus comprising circuitry configured to cause a wireless station to generate a frame configured for transmission over a millimeter Wave (mmWave) frequency band; and process directional transmission of the frame over a wide channel in the mmWave frequency band according to a band plan comprising a plurality of channels having a predefined channel width, and a plurality of wide channels comprising the wide channel, the wide channel having a width which is an integer multiple of the predefined channel width.

Example 2 includes the subject matter of Example 1, and optionally, wherein the wide channel comprises at least two channels of the plurality of channels having the predefined channel width.

Example 3 includes the subject matter of Example 2, and optionally, wherein the wide channel comprises a bonded channel formed by the at least two channels.

Example 4 includes the subject matter of any one of Examples 1-3, and optionally, wherein each wide channel of the plurality of wide channels comprises a different combination of at least two of the plurality of channels having the predefined channel width.

Example 5 includes the subject matter of any one of Examples 1-4, and optionally, wherein the plurality of channels having the predefined channel width comprises four channels, a channel of the four channels having the channel width of 2.16 Gigahertz (GHz).

Example 6 includes the subject matter of any one of Examples 1-5, and optionally, wherein the plurality of wide channels comprises at least two wide channels having a channel width of 4.32 Gigahertz (GHz).

Example 7 includes the subject matter of Example 6, and optionally, wherein the plurality of wide channels comprises first and second non-overlapping wide channels having the channel width of 4.32 GHz.

Example 8 includes the subject matter of Example 6, and optionally, wherein the plurality of wide channels comprises three overlapping wide channels having the channel width of 4.32 GHz.

Example 9 includes the subject matter of any one of Examples 1-8, and optionally, wherein the plurality of wide channels comprises one or more channels having a channel width of 6.48 Gigahertz (GHz).

Example 10 includes the subject matter of Example 9, and optionally, wherein the plurality of wide channels comprises a single channel having the channel width of 6.48 GHz.

Example 11 includes the subject matter of Example 9, and optionally, wherein the plurality of wide channels comprises first and second overlapping channels having the channel width of 6.48 GHz.

Example 12 includes the subject matter of any one of Examples 1-11, and optionally, wherein the plurality of wide channels comprises a channel having a channel width of 8.64 Gigahertz (GHz).

Example 13 includes the subject matter of any one of Examples 1-12, and optionally, wherein the mmWave frequency band is a Directional Multi-Gigabit (DMG) band.

Example 14 includes the subject matter of any one of Examples 1-13, and optionally, wherein the wireless station is a Directional Multi-Gigabit (DMG) Station (STA).

Example 15 includes the subject matter of any one of Examples 1-14, and optionally, comprising a transmitter to transmit the frame.

Example 16 includes the subject matter of any one of Examples 1-15, and optionally, comprising one or more directional antennas, a memory, and a processor.

Example 17 includes a system of wireless communication comprising a wireless station, the wireless station comprising one or more directional antennas; a memory; a processor; and a radio to process directional transmission of a frame over a wide channel in a millimeter Wave (mmWave) frequency band according to a band plan comprising a plurality of channels having a predefined channel width, and a plurality of wide channels comprising the wide channel, the wide channel having a width which is an integer multiple of the predefined channel width.

Example 18 includes the subject matter of Example 17, and optionally, wherein the wide channel comprises at least two channels of the plurality of channels having the predefined channel width.

Example 19 includes the subject matter of Example 18, and optionally, wherein the wide channel comprises a bonded channel formed by the at least two channels.

Example 20 includes the subject matter of any one of Examples 17-19, and optionally, wherein each wide channel of the plurality of wide channels comprises a different combination of at least two of the plurality of channels having the predefined channel width.

Example 21 includes the subject matter of any one of Examples 17-20, and optionally, wherein the plurality of channels having the predefined channel width comprises four channels, a channel of the four channels having the channel width of 2.16 Gigahertz (GHz).

Example 22 includes the subject matter of any one of Examples 17-21, and optionally, wherein the plurality of wide channels comprises at least two wide channels having a channel width of 4.32 Gigahertz (GHz).

Example 23 includes the subject matter of Example 22, and optionally, wherein the plurality of wide channels comprises first and second non-overlapping wide channels having the channel width of 4.32 GHz.

Example 24 includes the subject matter of Example 22, and optionally, wherein the plurality of wide channels comprises three overlapping wide channels having the channel width of 4.32 GHz.

Example 25 includes the subject matter of any one of Examples 17-24, and optionally, wherein the plurality of wide channels comprises one or more channels having a channel width of 6.48 Gigahertz (GHz).

Example 26 includes the subject matter of Example 25, and optionally, wherein the plurality of wide channels comprises a single channel having the channel width of 6.48 GHz.

Example 27 includes the subject matter of Example 25, and optionally, wherein the plurality of wide channels comprises first and second overlapping channels having the channel width of 6.48 GHz.

Example 28 includes the subject matter of any one of Examples 17-27, and optionally, wherein the plurality of wide channels comprises a channel having a channel width of 8.64 Gigahertz (GHz).

Example 29 includes the subject matter of any one of Examples 17-28, and optionally, wherein the mmWave frequency band is a Directional Multi-Gigabit (DMG) band.

Example 30 includes the subject matter of any one of Examples 17-29, and optionally, wherein the wireless station is a Directional Multi-Gigabit (DMG) Station (STA).

Example 31 includes a method to be performed at a wireless station, the method comprising: generating a frame configured for transmission over a millimeter Wave (mmWave) frequency band; and processing directional transmission of the frame over a wide channel in the mmWave frequency band according to a band plan comprising a plurality of channels having a predefined channel width, and a plurality of wide channels comprising the wide channel, the wide channel having a width which is an integer multiple of the predefined channel width.

Example 32 includes the subject matter of Example 31, and optionally, wherein the wide channel comprises at least two channels of the plurality of channels having the predefined channel width.

Example 33 includes the subject matter of Example 32, and optionally, wherein the wide channel comprises a bonded channel formed by the at least two channels.

Example 34 includes the subject matter of any one of Examples 31-33, and optionally, wherein each wide channel of the plurality of wide channels comprises a different combination of at least two of the plurality of channels having the predefined channel width.

Example 35 includes the subject matter of any one of Examples 31-34, and optionally, wherein the plurality of channels having the predefined channel width comprises four channels, a channel of the four channels having the channel width of 2.16 Gigahertz (GHz).

Example 36 includes the subject matter of any one of Examples 31-35, and optionally, wherein the plurality of wide channels comprises at least two wide channels having a channel width of 4.32 Gigahertz (GHz).

Example 37 includes the subject matter of Example 36, and optionally, wherein the plurality of wide channels comprises first and second non-overlapping wide channels having the channel width of 4.32 GHz.

Example 38 includes the subject matter of Example 36, and optionally, wherein the plurality of wide channels comprises three overlapping wide channels having the channel width of 4.32 GHz.

Example 39 includes the subject matter of any one of Examples 31-38, and optionally, wherein the plurality of wide channels comprises one or more channels having a channel width of 6.48 Gigahertz (GHz).

Example 40 includes the subject matter of Example 39, and optionally, wherein the plurality of wide channels comprises a single channel having the channel width of 6.48 GHz.

Example 41 includes the subject matter of Example 39, and optionally, wherein the plurality of wide channels comprises first and second overlapping channels having the channel width of 6.48 GHz.

Example 42 includes the subject matter of any one of Examples 31-41, and optionally, wherein the plurality of wide channels comprises a channel having a channel width of 8.64 Gigahertz (GHz).

Example 43 includes the subject matter of any one of Examples 31-42, and optionally, wherein the mmWave frequency band is a Directional Multi-Gigabit (DMG) band.

Example 44 includes the subject matter of any one of Examples 31-43, and optionally, wherein the wireless station is a Directional Multi-Gigabit (DMG) Station (STA).

Example 45 includes a product comprising one or more tangible computer-readable non-transitory storage media comprising computer-executable instructions operable to, when executed by at least one computer processor, enable the at least one computer processor to implement one or more operations at a wireless station, the operations comprising generating a frame configured for transmission over a millimeter Wave (mmWave) frequency band; and processing directional transmission of the frame over a wide channel in the mmWave frequency band according to a band plan comprising a plurality of channels having a predefined channel width, and a plurality of wide channels comprising the wide channel, the wide channel having a width which is an integer multiple of the predefined channel width.

Example 46 includes the subject matter of Example 45, and optionally, wherein the wide channel comprises at least two channels of the plurality of channels having the predefined channel width.

Example 47 includes the subject matter of Example 46, and optionally, wherein the wide channel comprises a bonded channel formed by the at least two channels.

Example 48 includes the subject matter of any one of Examples 45-47, and optionally, wherein each wide channel of the plurality of wide channels comprises a different combination of at least two of the plurality of channels having the predefined channel width.

Example 49 includes the subject matter of any one of Examples 45-48, and optionally, wherein the plurality of channels having the predefined channel width comprises four channels, a channel of the four channels having the channel width of 2.16 Gigahertz (GHz).

Example 50 includes the subject matter of any one of Examples 45-49, and optionally, wherein the plurality of wide channels comprises at least two wide channels having a channel width of 4.32 Gigahertz (GHz).

Example 51 includes the subject matter of Example 50, and optionally, wherein the plurality of wide channels comprises first and second non-overlapping wide channels having the channel width of 4.32 GHz.

Example 52 includes the subject matter of Example 50, and optionally, wherein the plurality of wide channels comprises three overlapping wide channels having the channel width of 4.32 GHz.

Example 53 includes the subject matter of any one of Examples 45-52, and optionally, wherein the plurality of wide channels comprises one or more channels having a channel width of 6.48 Gigahertz (GHz).

Example 54 includes the subject matter of Example 53, and optionally, wherein the plurality of wide channels comprises a single channel having the channel width of 6.48 GHz.

Example 55 includes the subject matter of Example 53, and optionally, wherein the plurality of wide channels comprises first and second overlapping channels having the channel width of 6.48 GHz.

Example 56 includes the subject matter of any one of Examples 45-55, and optionally, wherein the plurality of wide channels comprises a channel having a channel width of 8.64 Gigahertz (GHz).

Example 57 includes the subject matter of any one of Examples 45-56, and optionally, wherein the mmWave frequency band is a Directional Multi-Gigabit (DMG) band.

Example 58 includes the subject matter of any one of Examples 45-57, and optionally, wherein the wireless station is a Directional Multi-Gigabit (DMG) Station (STA).

Example 59 includes an apparatus of wireless communication by a wireless station, the apparatus comprising means for generating a frame configured for transmission over a millimeter Wave (mmWave) frequency band; and means for processing directional transmission of the frame over a wide channel in the mmWave frequency band according to a band plan comprising a plurality of channels having a predefined channel width, and a plurality of wide channels comprising the wide channel, the wide channel having a width which is an integer multiple of the predefined channel width.

Example 60 includes the subject matter of Example 59, and optionally, wherein the wide channel comprises at least two channels of the plurality of channels having the predefined channel width.

Example 61 includes the subject matter of Example 60, and optionally, wherein the wide channel comprises a bonded channel formed by the at least two channels.

Example 62 includes the subject matter of any one of Examples 59-61, and optionally, wherein each wide channel of the plurality of wide channels comprises a different combination of at least two of the plurality of channels having the predefined channel width.

Example 63 includes the subject matter of any one of Examples 59-62, and optionally, wherein the plurality of channels having the predefined channel width comprises four channels, a channel of the four channels having the channel width of 2.16 Gigahertz (GHz).

Example 64 includes the subject matter of any one of Examples 59-63, and optionally, wherein the plurality of wide channels comprises at least two wide channels having a channel width of 4.32 Gigahertz (GHz).

Example 65 includes the subject matter of Example 64, and optionally, wherein the plurality of wide channels comprises first and second non-overlapping wide channels having the channel width of 4.32 GHz.

Example 66 includes the subject matter of Example 64, and optionally, wherein the plurality of wide channels comprises three overlapping wide channels having the channel width of 4.32 GHz.

Example 67 includes the subject matter of any one of Examples 59-66, and optionally, wherein the plurality of wide channels comprises one or more channels having a channel width of 6.48 Gigahertz (GHz).

Example 68 includes the subject matter of Example 67, and optionally, wherein the plurality of wide channels comprises a single channel having the channel width of 6.48 GHz.

Example 69 includes the subject matter of Example 67, and optionally, wherein the plurality of wide channels comprises first and second overlapping channels having the channel width of 6.48 GHz.

Example 70 includes the subject matter of any one of Examples 59-69, and optionally, wherein the plurality of wide channels comprises a channel having a channel width of 8.64 Gigahertz (GHz).

Example 71 includes the subject matter of any one of Examples 59-70, and optionally, wherein the mmWave frequency band is a Directional Multi-Gigabit (DMG) band.

Example 72 includes the subject matter of any one of Examples 59-71, and optionally, wherein the wireless station is a Directional Multi-Gigabit (DMG) Station (STA).

Example 73 includes a apparatus comprising circuitry configured to cause a wireless station to process directional reception of a frame over a wide channel in the mmWave frequency band according to a band plan comprising a plurality of channels having a predefined channel width, and a plurality of wide channels comprising the wide channel, the wide channel having a width which is an integer multiple of the predefined channel width; and process at least a portion of the frame.

Example 74 includes the subject matter of Example 73, and optionally, wherein the wide channel comprises at least two channels of the plurality of channels having the predefined channel width.

Example 75 includes the subject matter of Example 74, and optionally, wherein the wide channel comprises a bonded channel formed by the at least two channels.

Example 76 includes the subject matter of any one of Examples 73-75, and optionally, wherein each wide channel of the plurality of wide channels comprises a different combination of at least two of the plurality of channels having the predefined channel width.

Example 77 includes the subject matter of any one of Examples 73-76, and optionally, wherein the plurality of channels having the predefined channel width comprises four channels, a channel of the four channels having the channel width of 2.16 Gigahertz (GHz).

Example 78 includes the subject matter of any one of Examples 73-77, and optionally, wherein the plurality of wide channels comprises at least two wide channels having a channel width of 4.32 Gigahertz (GHz).

Example 79 includes the subject matter of Example 78, and optionally, wherein the plurality of wide channels comprises first and second non-overlapping wide channels having the channel width of 4.32 GHz.

Example 80 includes the subject matter of Example 78, and optionally, wherein the plurality of wide channels comprises three overlapping wide channels having the channel width of 4.32 GHz.

Example 81 includes the subject matter of any one of Examples 73-80, and optionally, wherein the plurality of wide channels comprises one or more channels having a channel width of 6.48 Gigahertz (GHz).

Example 82 includes the subject matter of Example 81, and optionally, wherein the plurality of wide channels comprises a single channel having the channel width of 6.48 GHz.

Example 83 includes the subject matter of Example 81, and optionally, wherein the plurality of wide channels comprises first and second overlapping channels having the channel width of 6.48 GHz.

Example 84 includes the subject matter of any one of Examples 73-83, and optionally, wherein the plurality of wide channels comprises a channel having a channel width of 8.64 Gigahertz (GHz).

Example 85 includes the subject matter of any one of Examples 73-84, and optionally, wherein the mmWave frequency band is a Directional Multi-Gigabit (DMG) band.

Example 86 includes the subject matter of any one of Examples 73-85, and optionally, wherein the wireless station is a Directional Multi-Gigabit (DMG) Station (STA).

Example 87 includes the subject matter of any one of Examples 73-86, and optionally, comprising a receiver to receive the frame.

Example 88 includes the subject matter of any one of Examples 73-87, and optionally, comprising one or more directional antennas, a memory, and a processor.

Example 89 includes a system of wireless communication comprising a wireless station, the wireless station comprising one or more directional antennas; a memory; a processor; and a radio to process directional reception of a frame over a wide channel in a millimeter Wave (mmWave) frequency band according to a band plan comprising a plurality of channels having a predefined channel width, and a plurality of wide channels comprising the wide channel, the wide channel having a width which is an integer multiple of the predefined channel width.

Example 90 includes the subject matter of Example 89, and optionally, wherein the wide channel comprises at least two channels of the plurality of channels having the predefined channel width.

Example 91 includes the subject matter of Example 90, and optionally, wherein the wide channel comprises a bonded channel formed by the at least two channels.

Example 92 includes the subject matter of any one of Examples 89-91, and optionally, wherein each wide channel of the plurality of wide channels comprises a different combination of at least two of the plurality of channels having the predefined channel width.

Example 93 includes the subject matter of any one of Examples 89-92, and optionally, wherein the plurality of channels having the predefined channel width comprises four channels, a channel of the four channels having the channel width of 2.16 Gigahertz (GHz).

Example 94 includes the subject matter of any one of Examples 89-93, and optionally, wherein the plurality of wide channels comprises at least two wide channels having a channel width of 4.32 Gigahertz (GHz).

Example 95 includes the subject matter of Example 94, and optionally, wherein the plurality of wide channels comprises first and second non-overlapping wide channels having the channel width of 4.32 GHz.

Example 96 includes the subject matter of Example 94, and optionally, wherein the plurality of wide channels comprises three overlapping wide channels having the channel width of 4.32 GHz.

Example 97 includes the subject matter of any one of Examples 89-96, and optionally, wherein the plurality of wide channels comprises one or more channels having a channel width of 6.48 Gigahertz (GHz).

Example 98 includes the subject matter of Example 97, and optionally, wherein the plurality of wide channels comprises a single channel having the channel width of 6.48 GHz.

Example 99 includes the subject matter of Example 97, and optionally, wherein the plurality of wide channels comprises first and second overlapping channels having the channel width of 6.48 GHz.

Example 100 includes the subject matter of any one of Examples 89-99, and optionally, wherein the plurality of wide channels comprises a channel having a channel width of 8.64 Gigahertz (GHz).

Example 101 includes the subject matter of any one of Examples 89-100, and optionally, wherein the mmWave frequency band is a Directional Multi-Gigabit (DMG) band.

Example 102 includes the subject matter of any one of Examples 89-101, and optionally, wherein the wireless station is a Directional Multi-Gigabit (DMG) Station (STA).

Example 103 includes a method to be performed at a wireless station, the method comprising processing directional reception of a frame over a wide channel in the mmWave frequency band according to a band plan comprising a plurality of channels having a predefined channel width, and a plurality of wide channels comprising the wide channel, the wide channel having a width which is an integer multiple of the predefined channel width; and processing at least a portion of the frame.

Example 104 includes the subject matter of Example 103, and optionally, wherein the wide channel comprises at least two channels of the plurality of channels having the predefined channel width.

Example 105 includes the subject matter of Example 104, and optionally, wherein the wide channel comprises a bonded channel formed by the at least two channels.

Example 106 includes the subject matter of any one of Examples 103-105, and optionally, wherein each wide channel of the plurality of wide channels comprises a different combination of at least two of the plurality of channels having the predefined channel width.

Example 107 includes the subject matter of any one of Examples 103-106, and optionally, wherein the plurality of channels having the predefined channel width comprises four channels, a channel of the four channels having the channel width of 2.16 Gigahertz (GHz).

Example 108 includes the subject matter of any one of Examples 103-107, and optionally, wherein the plurality of wide channels comprises at least two wide channels having a channel width of 4.32 Gigahertz (GHz).

Example 109 includes the subject matter of Example 108, and optionally, wherein the plurality of wide channels comprises first and second non-overlapping wide channels having the channel width of 4.32 GHz.

Example 110 includes the subject matter of Example 108, and optionally, wherein the plurality of wide channels comprises three overlapping wide channels having the channel width of 4.32 GHz.

Example 111 includes the subject matter of any one of Examples 103-110, and optionally, wherein the plurality of wide channels comprises one or more channels having a channel width of 6.48 Gigahertz (GHz).

Example 112 includes the subject matter of Example 111, and optionally, wherein the plurality of wide channels comprises a single channel having the channel width of 6.48 GHz.

Example 113 includes the subject matter of Example 111, and optionally, wherein the plurality of wide channels comprises first and second overlapping channels having the channel width of 6.48 GHz.

Example 114 includes the subject matter of any one of Examples 103-113, and optionally, wherein the plurality of wide channels comprises a channel having a channel width of 8.64 Gigahertz (GHz).

Example 115 includes the subject matter of any one of Examples 103-114, and optionally, wherein the mmWave frequency band is a Directional Multi-Gigabit (DMG) band.

Example 116 includes the subject matter of any one of Examples 103-115, and optionally, wherein the wireless station is a Directional Multi-Gigabit (DMG) Station (STA).

Example 117 includes a product comprising one or more tangible computer-readable non-transitory storage media comprising computer-executable instructions operable to, when executed by at least one computer processor, enable the at least one computer processor to implement one or more operations at a wireless station, the operations comprising processing directional reception of a frame over a wide channel in the mmWave frequency band according to a band plan comprising a plurality of channels having a predefined channel width, and a plurality of wide channels comprising the wide channel, the wide channel having a width which is an integer multiple of the predefined channel width; and processing at least a portion of the frame.

Example 118 includes the subject matter of Example 117, and optionally, wherein the wide channel comprises at least two channels of the plurality of channels having the predefined channel width.

Example 119 includes the subject matter of Example 118, and optionally, wherein the wide channel comprises a bonded channel formed by the at least two channels.

Example 120 includes the subject matter of any one of Examples 117-119, and optionally, wherein each wide channel of the plurality of wide channels comprises a different combination of at least two of the plurality of channels having the predefined channel width.

Example 121 includes the subject matter of any one of Examples 117-120, and optionally, wherein the plurality of channels having the predefined channel width comprises four channels, a channel of the four channels having the channel width of 2.16 Gigahertz (GHz).

Example 122 includes the subject matter of any one of Examples 117-121, and optionally, wherein the plurality of wide channels comprises at least two wide channels having a channel width of 4.32 Gigahertz (GHz).

Example 123 includes the subject matter of Example 122, and optionally, wherein the plurality of wide channels comprises first and second non-overlapping wide channels having the channel width of 4.32 GHz.

Example 124 includes the subject matter of Example 122, and optionally, wherein the plurality of wide channels comprises three overlapping wide channels having the channel width of 4.32 GHz.

Example 125 includes the subject matter of any one of Examples 117-124, and optionally, wherein the plurality of wide channels comprises one or more channels having a channel width of 6.48 Gigahertz (GHz).

Example 126 includes the subject matter of Example 125, and optionally, wherein the plurality of wide channels comprises a single channel having the channel width of 6.48 GHz.

Example 127 includes the subject matter of Example 125, and optionally, wherein the plurality of wide channels comprises first and second overlapping channels having the channel width of 6.48 GHz.

Example 128 includes the subject matter of any one of Examples 117-127, and optionally, wherein the plurality of wide channels comprises a channel having a channel width of 8.64 Gigahertz (GHz).

Example 129 includes the subject matter of any one of Examples 117-128, and optionally, wherein the mmWave frequency band is a Directional Multi-Gigabit (DMG) band.

Example 130 includes the subject matter of any one of Examples 117-129, and optionally, wherein the wireless station is a Directional Multi-Gigabit (DMG) Station (STA).

Example 131 includes an apparatus of wireless communication by a wireless station, the apparatus comprising means for processing directional reception of a frame over a wide channel in the mmWave frequency band according to a band plan comprising a plurality of channels having a predefined channel width, and a plurality of wide channels comprising the wide channel, the wide channel having a width which is an integer multiple of the predefined channel width; and means for processing at least a portion of the frame.

Example 132 includes the subject matter of Example 131, and optionally, wherein the wide channel comprises at least two channels of the plurality of channels having the predefined channel width.

Example 133 includes the subject matter of Example 132, and optionally, wherein the wide channel comprises a bonded channel formed by the at least two channels.

Example 134 includes the subject matter of any one of Examples 131-133, and optionally, wherein each wide channel of the plurality of wide channels comprises a different combination of at least two of the plurality of channels having the predefined channel width.

Example 135 includes the subject matter of any one of Examples 131-134, and optionally, wherein the plurality of channels having the predefined channel width comprises four channels, a channel of the four channels having the channel width of 2.16 Gigahertz (GHz).

Example 136 includes the subject matter of any one of Examples 131-135, and optionally, wherein the plurality of wide channels comprises at least two wide channels having a channel width of 4.32 Gigahertz (GHz).

Example 137 includes the subject matter of Example 136, and optionally, wherein the plurality of wide channels comprises first and second non-overlapping wide channels having the channel width of 4.32 GHz.

Example 138 includes the subject matter of Example 136, and optionally, wherein the plurality of wide channels comprises three overlapping wide channels having the channel width of 4.32 GHz.

Example 139 includes the subject matter of any one of Examples 131-138, and optionally, wherein the plurality of wide channels comprises one or more channels having a channel width of 6.48 Gigahertz (GHz).

Example 140 includes the subject matter of Example 139, and optionally, wherein the plurality of wide channels comprises a single channel having the channel width of 6.48 GHz.

Example 141 includes the subject matter of Example 139, and optionally, wherein the plurality of wide channels comprises first and second overlapping channels having the channel width of 6.48 GHz.

Example 142 includes the subject matter of any one of Examples 131-141, and optionally, wherein the plurality of wide channels comprises a channel having a channel width of 8.64 Gigahertz (GHz).

Example 143 includes the subject matter of any one of Examples 131-142, and optionally, wherein the mmWave frequency band is a Directional Multi-Gigabit (DMG) band.

Example 144 includes the subject matter of any one of Examples 131-143, and optionally, wherein the wireless station is a Directional Multi-Gigabit (DMG) Station (STA).

Functions, operations, components and/or features described herein with reference to one or more embodiments, may be combined with, or may be utilized in combination with, one or more other functions, operations, components and/or features described herein with reference to one or more other embodiments, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus comprising circuitry configured to cause a wireless station to:
generate a frame configured for transmission over a millimeter Wave (mmWave) frequency band; and
process directional transmission of the frame over a wide channel in the mmWave frequency band according to a band plan comprising a plurality of channels having a predefined channel width, and a plurality of wide channels comprising the wide channel, the wide channel having a width which is an integer multiple of the predefined channel width.

2. The apparatus of claim 1, wherein the wide channel comprises at least two channels of the plurality of channels having the predefined channel width.

3. The apparatus of claim 2, wherein the wide channel comprises a bonded channel formed by the at least two channels.

4. The apparatus of claim 1, wherein each wide channel of the plurality of wide channels comprises a different combination of at least two of the plurality of channels having the predefined channel width.

5. The apparatus of claim 1, wherein the plurality of channels having the predefined channel width comprises four channels, a channel of said four channels having the channel width of 2.16 Gigahertz (GHz).

6. The apparatus of claim 1, wherein the plurality of wide channels comprises at least two wide channels having a channel width of 4.32 Gigahertz (GHz).

7. The apparatus of claim 6, wherein the plurality of wide channels comprises first and second non-overlapping wide channels having the channel width of 4.32 GHz.

8. The apparatus of claim 6, wherein the plurality of wide channels comprises three overlapping wide channels having the channel width of 4.32 GHz.

9. The apparatus of claim 1, wherein the plurality of wide channels comprises one or more channels having a channel width of 6.48 Gigahertz (GHz).

10. The apparatus of claim 9, wherein the plurality of wide channels comprises a single channel having the channel width of 6.48 GHz.

11. The apparatus of claim 9, wherein the plurality of wide channels comprises first and second overlapping channels having the channel width of 6.48 GHz.

12. The apparatus of claim 1, wherein the plurality of wide channels comprises a channel having a channel width of 8.64 Gigahertz (GHz).

13. The apparatus of claim 1, wherein the mmWave frequency band is a Directional Multi-Gigabit (DMG) band.

14. The apparatus of claim 1, wherein the wireless station is a Directional Multi-Gigabit (DMG) Station (STA).

15. The apparatus of claim 1 comprising a transmitter to transmit said frame.

16. The apparatus of claim 1 comprising one or more directional antennas, a memory, and a processor.

17. A product comprising one or more tangible computer-readable non-transitory storage media comprising computer-executable instructions operable to, when executed by at least one computer processor, enable the at least one computer processor to implement one or more operations at a wireless station, the operations comprising:
generating a frame configured for transmission over a millimeter Wave (mmWave) frequency band; and
processing directional transmission of the frame over a wide channel in the mmWave frequency band according to a band plan comprising a plurality of channels having a predefined channel width, and a plurality of wide channels comprising the wide channel, the wide channel having a width which is an integer multiple of the predefined channel width.

18. The product of claim 17, wherein the wide channel comprises at least two channels of the plurality of channels having the predefined channel width.

19. The product of claim 17, wherein each wide channel of the plurality of wide channels comprises a different combination of at least two of the plurality of channels having the predefined channel width.

20. An apparatus comprising circuitry configured to cause a wireless station to:
process directional reception of a frame over a wide channel in the mmWave frequency band according to a band plan comprising a plurality of channels having a predefined channel width, and a plurality of wide channels comprising the wide channel, the wide channel having a width which is an integer multiple of the predefined channel width; and
process at least a portion of the frame.

21. The apparatus of claim 20, wherein the wide channel comprises at least two channels of the plurality of channels having the predefined channel width.

22. The apparatus of claim 21, wherein the wide channel comprises a bonded channel formed by the at least two channels.

23. A product comprising one or more tangible computer-readable non-transitory storage media comprising computer-executable instructions operable to, when executed by at least one computer processor, enable the at least one computer processor to implement one or more operations at a wireless station, the operations comprising:
processing directional reception of a frame over a wide channel in the mmWave frequency band according to a band plan comprising a plurality of channels having a predefined channel width, and a plurality of wide channels comprising the wide channel, the wide channel having a width which is an integer multiple of the predefined channel width; and
processing at least a portion of the frame.

24. The product of claim 23, wherein the plurality of wide channels comprises at least two wide channels having a channel width of 4.32 Gigahertz (GHz).

25. The product of claim 23, wherein the plurality of wide channels comprises one or more channels having a channel width of 6.48 Gigahertz (GHz).
